(19) United States
(12) Patent Application Publication
(10) Pub. No.: US 2015/0134421 A1
(43) Pub. Date: May 14, 2015

(54) OPTIMIZING CUSTOMER PROMOTIONS

(71) Applicant: Eugene DUPONT, Winter Park, FL (US)

(72) Inventor: Eugene DUPONT, Winter Park, FL (US)

(21) Appl. No.: 14/080,503

(22) Filed: Nov. 14, 2013

(51) Int. Cl. G06Q 30/02

(52) U.S. Cl. CPC G06Q 30/0205; G06Q 30/0255
USPC 705/7.34

(57) ABSTRACT

Processes for managing customers that visit one or more locations, such as a nightclub, are described. One example process may include electronically obtaining customer information encoded on an identification document, such as a driver's license, and verifying that the customer satisfies a rule for being admitted to the location based on customer information. A visual indicator may be presented to the user indicating whether or not the customer is authorized to enter the location based on the rule. The process may further include generating a customer record and storing customer information therewith. The records may be used to track activity of the customer within the location and determine customer preferences. Rewards, promotions, notifications, advertisements, and the like, may be presented to the customer based on their preferences and spending habits. Customers may further make reservations and information associated with those reservations may be stored with the customer's record.

### BACKGROUND

1. Field

The present disclosure relates generally to the analysis of customer actions and habits and, more specifically, to a process for generating client information allowing directed promotions.

2. Description of Related Art

Promotional activities may be more successful if they are properly targeted to a specific audience, which may depend on having data to make informed decisions on what a large group of potential customers wants. Industries, such as grocery stores, airlines, and car rental companies, have developed rewards cards that enable customers to receive additional benefits while enabling companies to gather data regarding their customers' spending and usage habits. However, in other industries, these types of programs have not been used for various reasons relating to the impracticality of signing users up to reward programs, infrequent visits by customers to a large number of separately owned entities, and other issues.

### BRIEF SUMMARY

Methods for tracking customer activity are provided. One example method may include receiving customer identification information for a customer attempting to enter a location, wherein access to the location is restricted based one or more rules, and wherein the customer identification information was extracted from a first identification document that is encoded with the customer identification information; verifying that the customer is authorized to enter the location based on the one or more rules; causing a display of an indication of whether the customer is authorized to enter the location based on the one or more rules; identifying a customer record associated with the customer in a customer database based on the customer identification information; updating activity data of the customer record to reflect the customer entering the location; tracking purchases made at the location using a second identification document associated with the customer; and in response to the activity data indicating that the customer has entered the location and in response to identifying a match between the customer record and the second identification document, updating the customer record based on the tracked purchases.

In some examples, the customer information comprises a date of birth for the customer; the one or more rules comprises a minimum age requirement; and verifying that the customer is authorized to enter the location based on the one or more rules comprises calculating the customer's age based on the date of birth and comparing the calculated age with the minimum age requirement.

In some examples, identifying the customer record associated with the customer comprises: in response to the customer not having a customer record in the customer database, causing a display of an interactive form to receive information for the customer; receiving information entered into the interactive form; and creating the customer record using the received information entered into the interactive form.

In some examples, receiving the customer identification information comprises receiving the customer identification information from a handled device comprising an optical scanner or a magnetic scanner, and wherein the handheld device extracted the customer identification information from the first identification document using the optical scanner or the magnetic scanner.

In some examples, the customer record associated with the customer comprises a name, a spending history, and an e-mail address for the customer.

In some examples, the method further includes in response to identifying the customer record associated with the customer, causing a display of at least a portion of data contained in the customer record.

In some examples, updating the activity data of the customer record comprises updating the customer record to include a date and time that the customer entered the location.

In some examples, the first identification document comprises a driver's license, and wherein the second identification document comprises a credit card. In other examples, identifying a match between the customer record and the second identification document comprises comparing a name associated with the credit card with a name associated with the customer record.

In some examples, the customer database comprises a plurality of customer records, each record having contact information associated therewith, and wherein the method further comprises: filtering the plurality of customer records using one or more criteria; and transmitting a marketing message to the filtered customer records.

Systems and computer-readable storage media for carrying out the processes for tracking customer activity are also described.

### DESCRIPTION OF THE FIGURES

FIG. 1 depicts a flowchart for an exemplary process for managing and tracking customer activity at a location according to various examples.

FIG. 2 depicts a screenshot of a handheld device for scanning a document for customer identification information according to various examples.

FIG. 3 depicts a block diagram of an exemplary network of customer management terminals connected to a customer database configured to operate according to various examples.

FIG. 4 depicts a screenshot of a handheld device displaying an exemplary interface form for receiving customer information according to various examples.

FIG. 5 depicts a screenshot of a handheld device displaying an exemplary notes interface for associating notes with a customer according to various examples.

FIG. 6 depicts a screenshot of a handheld device displaying an exemplary list of customers according to various examples.

FIG. 7 depicts a screenshot of a handheld device displaying an exemplary reservations interface according to various examples.

FIG. 8 depicts a screenshot of a handheld device displaying an exemplary interface for making a reservation according to various examples.

FIG. 9 depicts a screenshot of a handheld device displaying an exemplary interface for displaying reservation details according to various examples.

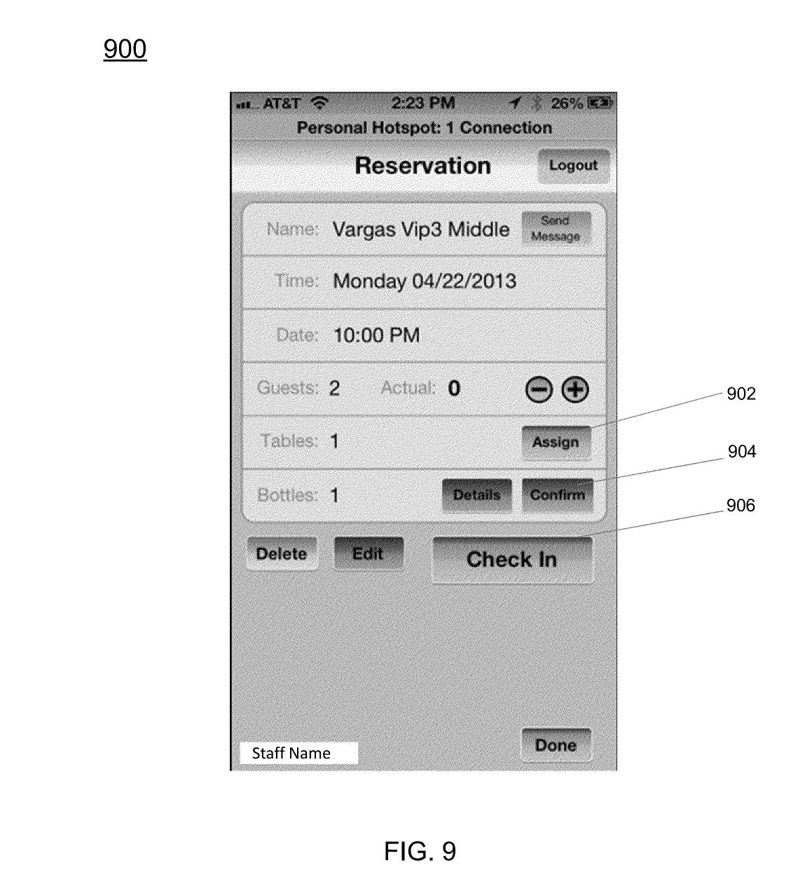

FIG. 10 depicts a block diagram of an exemplary computer that may be configured as a customer management terminal according to various examples.

FIG. 11 depicts a block diagram of an exemplary handheld computer that may be configured as a customer management terminal according to various examples.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Systems and processes for managing customers that visit one or more locations, such as a nightclub, are described. One example process may include electronically obtaining customer information encoded on an identification document, such as a driver's license, and verifying that the customer satisfies a rule for being admitted to the location based on customer information. The process may further include generating or identifying an existing customer record for the customer. The record may be used to track activity of the customer within the location and determine customer preferences. Rewards, promotions, notifications, advertisements, and the like, may be presented to the customer based on their preferences and spending habits. Customers may further make reservations and information associated with those reservations may be stored with the customer's record.

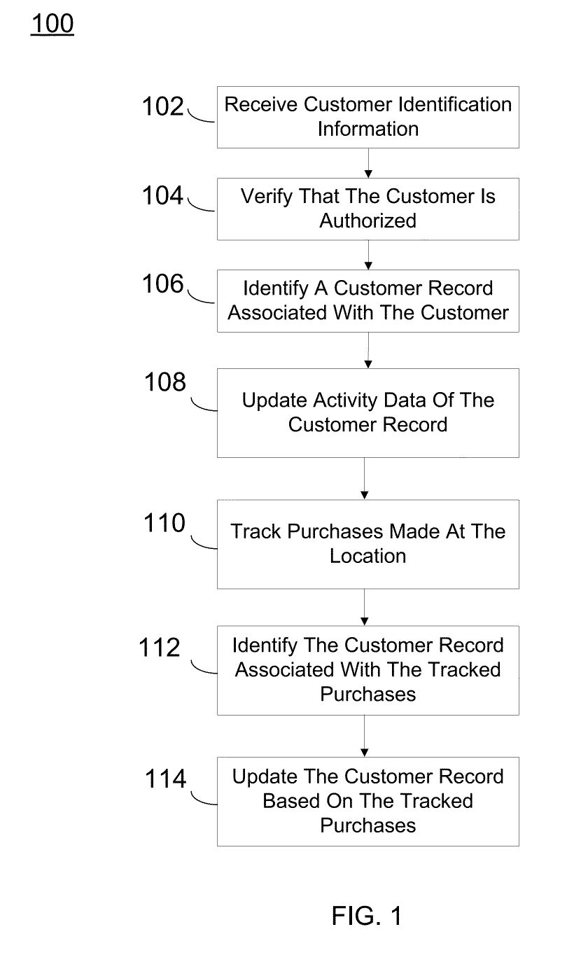

FIG. 1 illustrates an exemplary process 100 for managing and tracking customer activity at a location. Each of the operations of the exemplary process will be described in further detail below. For ease of discussion, the exemplary process will be described as being performed on a customer management terminal in the form of a handheld computer, such as a smartphone or a tablet computer. However, it should be understood that other computing devices, such as netbooks, laptops, desktops, computers running a thin client, and the like, could also be used to implement the customer management terminal. Additionally, other exemplary processes with optional or modified operations according to the present disclosure will be discussed. Moreover, for ease of explanation and to illustrate many of the advantages of the present disclosure, the operations below are described with respect to a nightclub. Unless expressly stated, the details specific to a nightclub should not be read as limiting on the claims.

At block 102, customer identification information for a customer present at a location may be received. The location may be any location where it may be desirable to manage customer admittance or attendance. Example locations include venues, sporting events, bars, nightclubs, restaurants, concert halls, and the like. The customer identification information may include, for example, a name, a date of birth, an indication of the identification (e.g., driver's license or passport number), an address, a user name, and the like. The customer identification information may also include biometric data, such as finger print data or retinal scan data, which may be stored on, or associated with, an identification document. The customer identification information may be received by the customer management terminal and, in some cases, provided to a remote server.

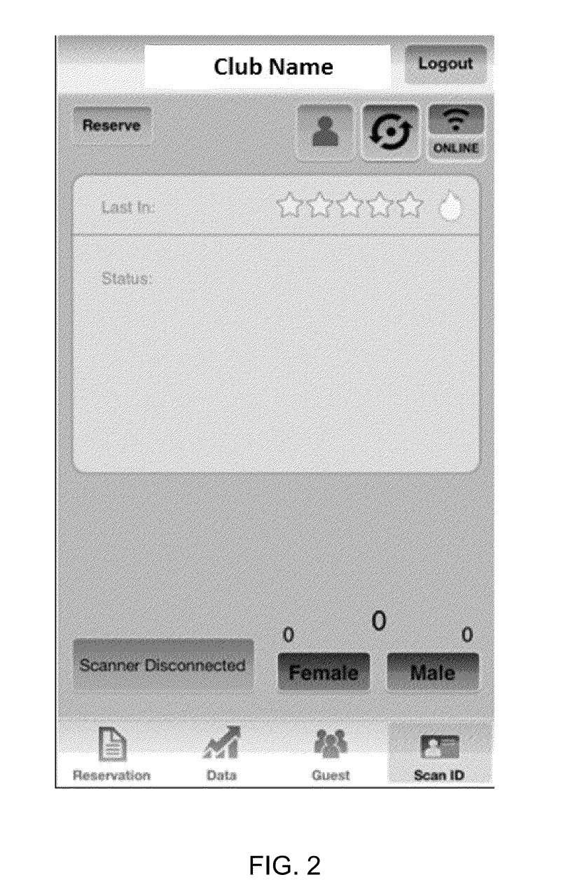

As noted above, the example location discussed herein is a nightclub. To comply with local laws regarding alcohol, nightclubs may employ a bouncer that checks customer identifications at the door. In the current example, the bouncer may use a smartphone or tablet computer to obtain the customer information. For example, the bouncer may use a handheld computer with an optical scanner to scan an image of an identification document, such as a driver's license or passport. The image may include a linear bar code, a 2D bar code, a quick response (“QR”) code, a picture of an identification number (e.g., driver's license or passport number) suitable for optical character recognition (“OCR”), or the like. The image may be used to determine an indication (e.g., an identification number) that identifies the customer. In other examples, the handheld computer may include a magnetic scanner or radio receiver to obtain the customer information from a magnetic strip or radio frequency ID (“RFID”) chip on the identification document. In still other examples, the handheld computer may prompt the user (i.e., the bouncer) to manually enter the customer information. FIG. 2 depicts an example screenshot of an interface of the handheld computer that may be used to scan an identification document of the customer.

Once the handheld computer receives the customer identification information, the process may proceed to block 104. At block 104, the customer management terminal (e.g., the handheld computer) may verify the customer as being authorized based on one or more rules. For example, a nightclub may require that a customer meet a certain age requirement (e.g., >=18 or >=21) to enter. As another example, laws may place an age limit for a nightclub based on the type of location. In the current example, using a nightclub as the location, the nightclub operator may require that all customers are 21 or over so that additional age checks are not required for customers to purchase alcohol. In this example, the handheld computer or a remote computing device may use the customer information from the customer identification information received at block 102 to determine whether the customer is over 21. For example, if the customer's date of birth is in included in the customer identification information, then the handheld computer may use that information to determine the customer's current age. If, based on the calculated age, the customer is 21 or over, then an indication may be displayed that the customer meets this requirement. While the customer management terminal can be used to the determine a name, age, etc., of a customer encoded on an identification document (e.g., a driver's license, passport, or the like), it may be advisable for the operator of the customer management terminal to perform additional verification steps to determine that the identification document is valid and that the information contained therein accurately identifies the customer. This can be beneficial as some identification documents can be forged in such a way that the customer management terminal may not be able to determine its authenticity.

Instead of using the customer's date of birth, if the customer information includes an indication of identification (e.g., driver's license or passport number), then the indication may be sent to a server for verification to determine if the customer meets the rule. In some cases, these verification servers may be operated by the government, which may have the added benefit of allowing for verification that the identification document is valid. In other cases, the verification servers may be operated by a private third party that may provide the verification service for a fee.

In some examples, an indication of the result of the verification performed at block 104 may be provided. For example, a display of the handheld computer may indicate whether the customer is authorized, according to the rule at block 104, to be admitted to the location. In the current example of a nightclub, if the handheld computer or remote verification server determines that the customer is above the local drinking age, the handheld computer may display a message to the user (e.g., the bouncer) that the customer is authorized to enter the nightclub. Similarly, if the handheld computer or verification server determines that the customer is under age, the handheld computer may display a message to the bouncer indicating that the customer should not be allowed to enter the nightclub.

At block 106, a customer record associated with the customer may be identified. The customer record may be stored in a local or remote customer database and may include any relevant information associated with the customer, such as age, gender, VIP rating, average amount of money previously spent (e.g., check average), average tip amount, date of last visit, items purchased during last visit, preferences (e.g., drink or food preferences), contact information, or the like. The customer database may contain a list of every customer to have visited the location or every customer to have visited related locations (e.g., other commonly owned nightclubs). In other examples, only a subset of customers may be stored. In another example, the customer database may be maintained by a third party that aggregates data from many different locations owned by different users. In some examples, the customer record associated with the customer may be identified by comparing some or all of the customer identification information obtained at block 102 with the customer database. In one example, the handheld device may be equipped with networking access through WiFi or some other type of wireless networking technology. The handheld computer may use the networking capabilities to transmit the customer identification information to a server associated with the customer database to have the server identify an associated customer record. In another example, the handheld computer may store a copy of the customer database on internal storage (e.g., when a wireless connection is unavailable). When using an internally stored database, the handheld computer may store updates to the customer database internally in real time and update a local or remote customer database at the end of some interval of time (e.g., when the location closes or when wireless connectivity is restored). The internally stored database may also receive updates to the database at this time.

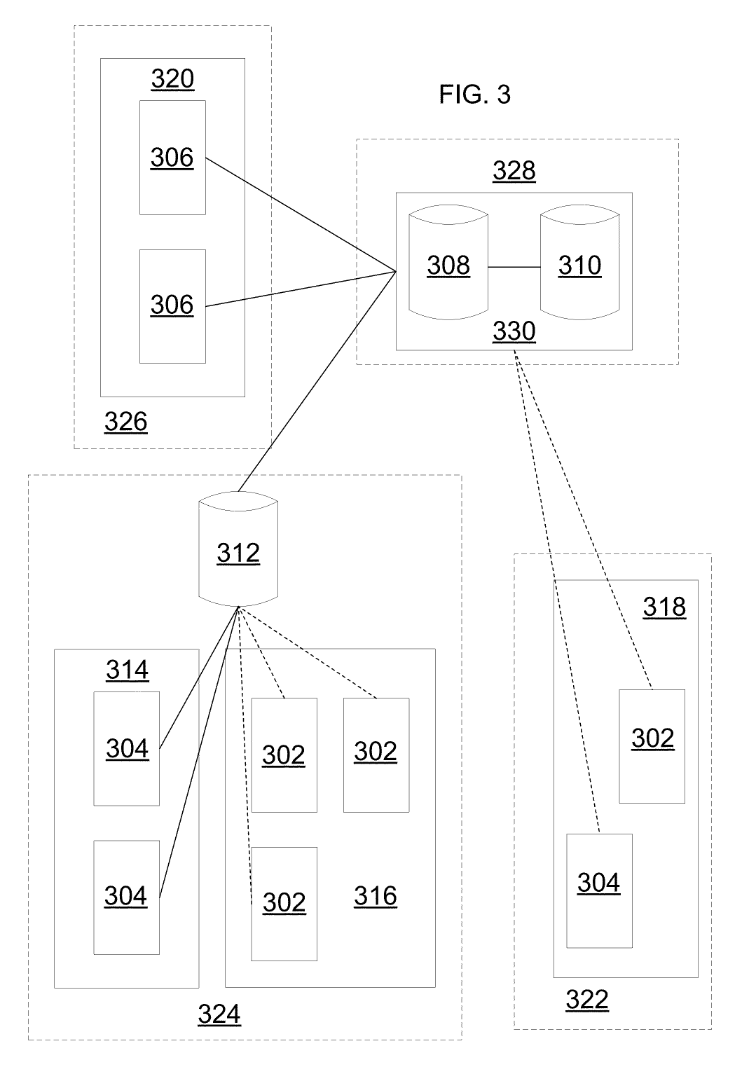

As an example of accessing the customer database, FIG. 3 depicts a network that may be used to implement examples of the present disclosure. FIG. 3 depicts four locations, 314, 316, 318, and 320. Locations 314 and 316 may be owned by the same user 324, while locations 318 and 320 may be owned by different users 322 and 326, respectively. Customer database 330, which includes databases 308 and 310, may be owned and operated by third party 328 that provides services to the users 322, 324, and 326.

Each location depicted in FIG. 3 may be configured to operate in a slightly different manner. However, each location may still be operated according to examples of the present disclosure. Each location may include one or more operators using one or more customer management terminals, 302, 304, and 306. Customer management terminal 302 may include a handheld computer (e.g., a smartphone or a tablet), customer management terminal 304 may include a desktop computer, and customer management terminal 306 may include a device running a thin client. Customer management terminals 302, 304, and 306 may interact with the customer database 330 in a variety of manners.

For example, location 320 may include two customer management terminals 306 that couple directly to customer database 330 using wireless and/or wired networks (e.g., the Internet, WiFi networks, local area networks, wide area networks (“WAN”), wireless WANs (“WWAN”), and the like). This configuration gives user 326 access to the most up-to-date data, but may leave user 326 susceptible to network outages and latency issues relating to interfacing with a remote database.

As another example, because user 324 owns two locations, 314 and 316, user 324 may have a local customer database 312 that contains a copy of (or a copy of a portion of) customer database 330. In one case, local customer database 312 may include only the portions of customer database 330 that were created by operators working at locations 314 and 316, which are owned by user 324. In another case, local customer database 312 may include an exact copy of customer database 330.

Customer management terminals 302 and 304 may interact with local customer database 312 in various manners. For example, customer management terminals 304 of location 314 may communicate in real time over wireless or wired networks with local customer database 312. As another example, customer management terminals 302 of location 316 may communicate with local customer database 312 only intermittently or periodically. In this example, copies of local customer database 312 may be stored locally on customer management terminals 302. Updates may be sent and received between customer management terminals 302 and local customer database 312 intermittently or periodically (e.g., once every hour, once every day, at the close of business each day, every 100 record updates, etc.). Updates between local customer database 312 and customer database 330 may be carried out on a similar intermittent or periodic schedule (e.g., once every hour, once every day, at the close of business each day, every 100 record updates, etc.).

As yet another example, location 318 may use a similar communication method as location 316, except instead of communicating with a local customer database, customer management terminals 302 and 304 may intermittently or periodically communicate with customer database 330. This configuration avoids latency issues associated with frequently communicating with a remote database and avoids the cost and complexity associated with a local customer database. However, this configuration may not give user 322 access to the most up-to-date information.

In FIG. 3, customer database 330 is depicted as a collection of two databases 308 and 310. However, this is only one example. A customer database may include any number of databases running on one or more severs. Additionally, a customer database may be replicated in multiple locations to provide for increased capacity and data redundancy. A customer database may also have one or more tables that each store information relating to the customers, locations, and the like.

Customers in the customer database may be identified by a unique string of characters. For example, the unique string of characters may be the indication of the identity of the customer from operation 102 (e.g., a driver's license or passport number). In another example, the unique string of characters may be a hash string created from one or more pieces of information (e.g., name, address, driver's license number, passport number, and the like) available from a customer document (e.g., driver's license, passport, etc.) associated with the customer. Using a hash string may have the added benefit of providing a level of privacy to the customer by using a unique string of characters that is not readily identifiable with the customer outside of the customer database.

The unique string of characters may be used at block 106 to identify the customer record in the customer database by the handheld device or the remote server. However, if no match is found, this may indicate that this customer has never visited a location that causes customer information to be stored in the customer database. Alternatively, the customer may have declined to be in the customer database. In some examples, if no customer record is found, a record may be created for the customer. In some examples, a customer record may automatically be created using the customer identification information obtained at block 102. In other examples, the handheld device may display an interface form to receive information associated with the customer. In one case, the customer may decline to be entered into the database and no further interaction with the customer database is needed for the customer. In another case, the customer may choose to provide information to be associated with the unique string of characters that identifies the customer. In still another case, the nightclub may require that the customer agree to being entered into the database to enter the nightclub. For example, this requirement may aid in providing for a safe and secure environment by tracking and excluding known troublemakers.

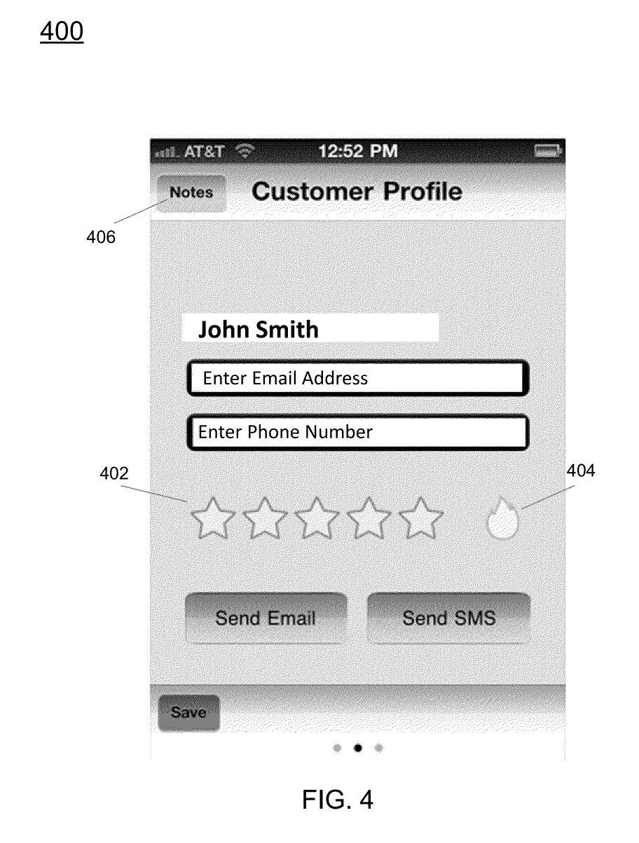

As an example, FIG. 4 depicts a screen capture from a handheld computer operating in accordance with the exemplary process. The customer “JOHN SMITH” has been found to be absent from the customer database. The handheld computer is displaying an interface form 400 that allows information, such as customer name, an e-mail address, or phone number, to be entered. The user may be given the option to input information which will allow the nightclub to keep the customer informed of events at the nightclub. In other examples, the interface form may also present an end user license agreement (“EULA”) and/or additional fields that allow other information associated with the customer, such as address, sex, physical attributes, or a picture, to be entered. In some cases, some information, such as address and physical attributes, could be automatically loaded into the interface form if that information is on the document associated with the customer discussed above in operation 102. In other cases, all fields of the interface form may be left blank regardless of whether the information is already present on the document associated with the customer.

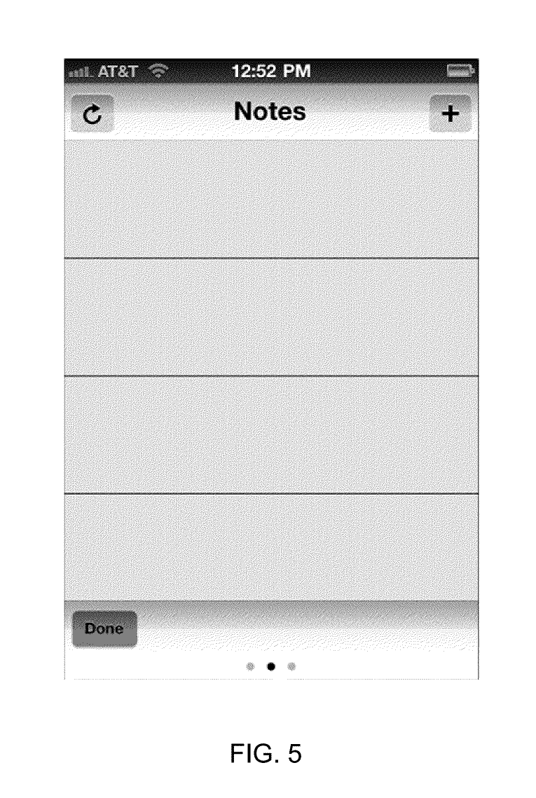

FIG. 4 also shows that the interface form may include indicators 402 and 404, which may be used to rate subjective or objective qualities of the customer. For example, if customer arrived with other important customers, indicator 402 may have all five stars filled in. In one example, indicator 404 may be marked if the operator subjectively determines that the customer is attractive. Button 406 allows notes to be entered and associated with the customer's record on the customer database. FIG. 5 depicts a screenshot showing the notes interface 500 in which a user may type any desired notes to be associated with the customer.

In other examples, the customer may be entered into the database prior to the customer reaching the location. For example, another bouncer could create customer records of customers that are waiting in line to enter the location. As another example, a customer may create a customer record by linking or otherwise sharing a social networking profile with an account in the customer database.

Once the customer record has been created, an automatic e-mail, social networking message, or other similar form of communication may be sent the customer so that the customer can verify that the information in the customer record is correct. Additionally, the customer may be invited to join the nightclub's social networking pages.

Referring back to process 100 of FIG. 1, once an existing customer record is identified or a new customer record is generated, the process may proceed to block 108. At block 108, activity data of the customer record may be updated. The activity data may include data associated with the customer entering the location, such as the dates and times that the customer visits various locations, the type of car that the customer arrived in, the number of other customers entering with the customer, the sex of the customers entering with the customer, and the like. Thus, at block 108, the handheld device may record the time and date that the customer identification is received at block 102 along with any other activity data and may transmit this data to be stored in the customer database. There, the customer record may be updated to reflect the recent activity of visiting the location by the customer.

In some examples, after block 108, the handheld computer may receive information about the customer from the customer database and display some or all of the information to the user of the device. The customer information may include any stored characteristics about the customer, such as an average amount previously spent in the club, a VIP rating, average tip amount, date of last visit, items purchased during last visit, preferences, or the like. This allows the bouncer or other front-end staff to identify important customers for which they may want to provide additional services. For example, if a customer identified using process 100 is a high spender with a 5-star rating, this information may be stored in the customer database and provided to the handheld device, allowing the front-end staff to identify this VIP and offer him free table service in the club. This information may be presented to the operator of the user based on the customer identification information (e.g., as received from a driver's license, passport, etc.).

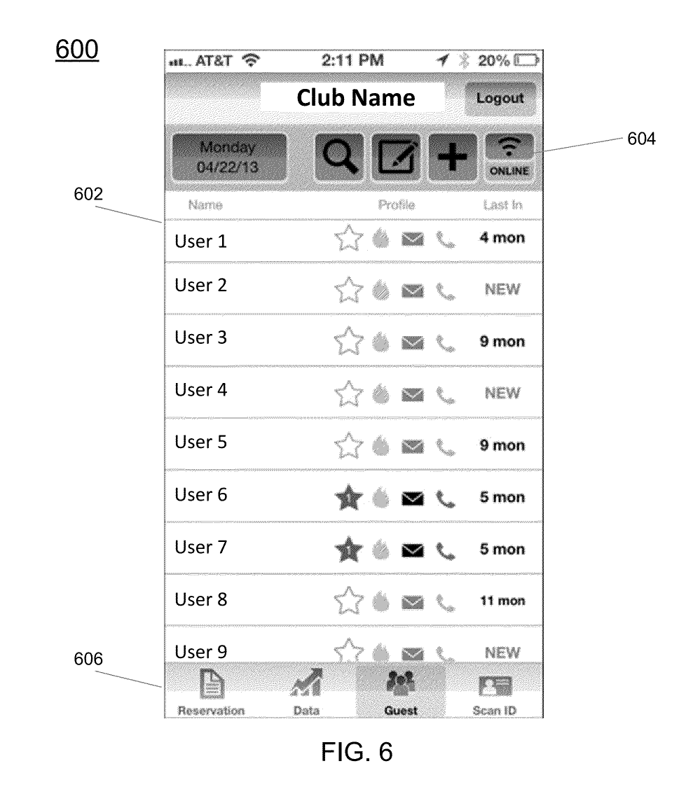

After a customer is admitted into the nightclub, other customer management terminals may be used to further interface with the customer database. For example, another handheld computer used by a nightclub host may display a list of all customers or only current VIP customers in the nightclub. FIG. 6 depicts a screenshot of a handheld computer displaying an example interface 600 containing this type of information.

In some examples, the example interface 600 shown in FIG. 6 may be used by a bouncer or doorman to admit customers into the nightclub. For example, the interface may include names 602 of customers on a guest list. If the customer's name appears on the list, the bouncer may admit the customer into the night club. The bouncer may also check off names from the guest list as customers arrive. This interface may also display the subjective rank of the customer, whether email and phone number information is available for the customer, and the date the customer last visited the particular establishment. Interface 600 may further include indicator 604 that shows whether or not the device has a wireless connection for purposes of connecting to the third party service (e.g., third party 328 having customer database 330).

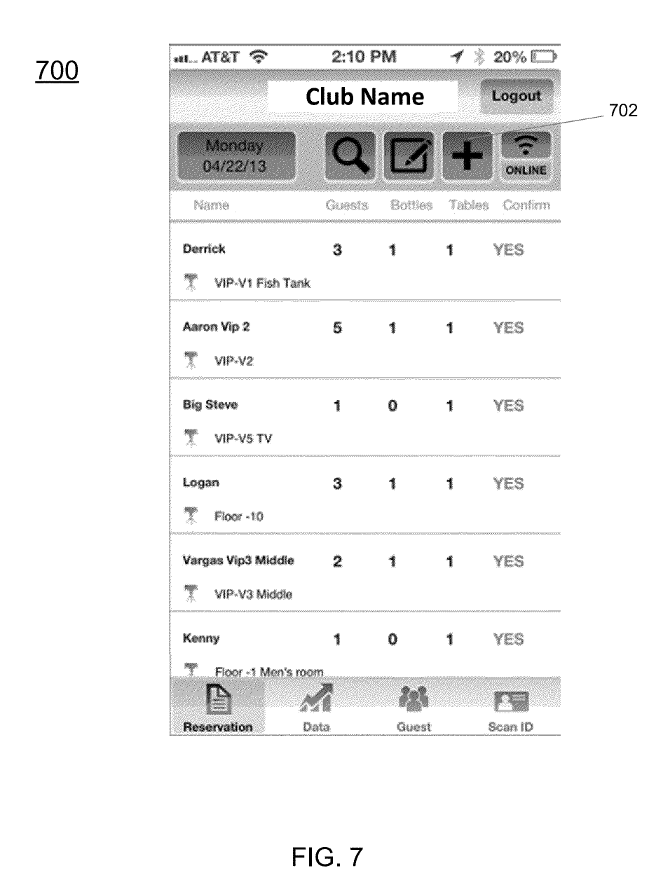

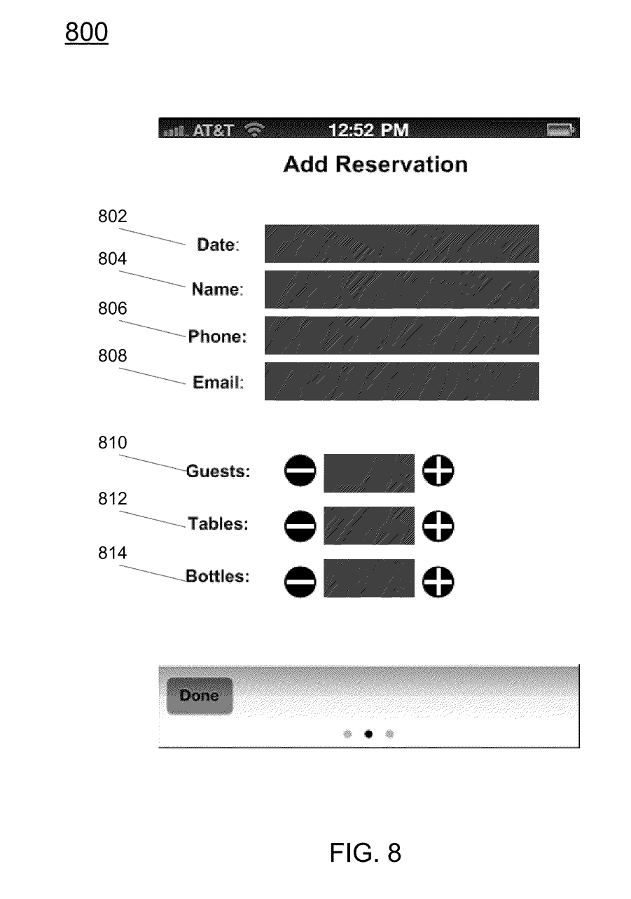

In other examples, the interface shown in FIG. 6 may also be used to make reservations for a particular customer. For example, a user may select a reservation button 606 to cause a display of an example reservation interface 700 shown in FIG. 7. Interface 700 may list all current reservations, along with their relevant information, such as number of guests, number of bottles, number of tables, and whether the reservation has been confirmed by a manager. Interface 700 may include a make reservation button 702 that causes the display of “Add Reservation” interface 800. Interface 800 may include input fields for entering information relevant to making a reservation at a particular location or establishment. For example, a nightclub may have fields similar to that shown in FIG. 8. As examples, interface 800 includes field 802 for entering the date of the reservation, field 804 for entering customer's name, field 806 for entering the customer's phone number, field 808 for entering the customer's email address, field 810 for entering a number of guests, field 812 for entering the number of tables, and field 814 for entering the number of bottles. Also, in some examples, fields 810, 812, and 814 may include plus/minus buttons for adjusting the desired number of guests, tables, and bottles.

In some examples, the information entered into interface 800 may be transmitted by the handheld computer to a local or remote database used by the establishment to track reservations. These databases may be the same or different databases than those described above with respect to FIG. 3. In this way, any user of a customer management terminal that is connected to the establishment's system may have access to all customer records, guest lists, reservations, and the like.

Referring back to interface 700, a selection of one of the listed reservations may cause a display of interface 900 on the handheld device. Interface 900 may include detailed information about the reservation, such as the date, time, number of guests on the reservation, number of actual guests in attendance, assigned table number, and number of bottles. Interface 900 may include table assignment button 902 that allows the user to assign a particular table to the reservation, confirmation button 904 for confirming the number of bottles ordered, and check-in button 906 that allows the user to check in the guests when they arrive. Other information, such as the staff member the created the reservation, may also be displayed. All information entered or edited using interface 900 may be transmitted by the handheld computer to the local or remote database used by the establishment to track reservations. These databases may be the same or different databases than those described above with respect to FIG. 3.

Referring back to process 100 shown in FIG. 1, once the customer enters the location, purchases made at the location may be tracked at block 110. Using this purchasing data, as well as other types of data, nightclubs can implement preferred-customer programs that reward customers that meet certain requirements, such as regularly attending certain clubs, spending certain amounts, or bringing certain types of other customers to the nightclub. Customers may be able to link their spending in the location with their customer record in the customer database so that they may monitor their spending habits at the nightclub. In some examples, block 110 may include receiving credit card information at a computing device, such as a handheld computing device, desktop computer, netbook, laptop, or the like. The credit card information may include the name of the customer as it appears on the credit card. Using the nightclub example provided above, a customer may use a credit card to purchase drinks in the nightclub. The name of the customer on the credit card may be recorded by the point of sale computing device used to facilitate the transaction. The purchases made with the credit card may be tracked and stored by the computing device. For example, the number and types of shots, dollars spent, and the like, may be tracked for the credit card throughout the night. Block 110 may be used to track the purchases of any number of credit cards.

At block 112, the credit card information and the purchase information obtained at block 110 may be transmitted to a local or remote server that tracks the purchase history of customers. In some examples, the local or remote server may be the third party 328 that includes the customer database 330, described above with respect to FIG. 3. At the server, the name on the credit card obtained at block 110 may be matched to a customer record of a customer on the list of customers that are currently known to be in the nightclub (e.g., as stored in customer database 330).

At block 114, all purchases made with the credit card as tracked at block 110 may then be used to modify the customer record of the identified customer. Alternatively, the credit card number could be manually linked with the customer in the database. As another alternative, a customer's drinks may be manually linked with the customer at the time the customer orders or pays for the drinks. In this way, the nightclub may track the amount of money the customer typically spends, the types of drinks they prefer, and any other preferences based on the customer's spending habits. In some examples, this purchase information may be provided to a bouncer or doorman after block 108, as described above.

In the example nightclub, the software that implements the operations of process 100 may be integrated with the point of sale (“POS”) software used to handle customer purchases and credit card processing. This integration simplifies the association of a customer's database record with the customer's purchases. In other example locations, the POS software and the software implementing process 100 may be separate and require additional steps to associate a customer's database record with the customer's purchases. In one case, an integration server acts to enable data exchange between the POS software and the software implementing process 100. The integration server could be a part of the POS software or the software implementing process 100. In another case, the POS software may store all of the customer purchases for a time interval (e.g., one night). The store purchases may then be combined into the customer database at the end of the interval.

In still another example, an operator of a handheld computer with access to the customer database can note or ban certain customers that act illegally or inappropriately. This information may be displayed to the bouncer at the door when the customer first tries to enter the nightclub so that the troublemaker is denied entry to the nightclub.

In some examples, the server associated with the customer database may provide reminders for customers' birthdays. These reminders may be provided to the users of the system, such as users 322, 324, and 326, to allow the users to optionally provide special offers to the customers on their birthdays.

Once the customer database (e.g., database 330) is populated with customer records and information associated with the customer records, the customer database may be used to target marketing efforts to maximize customer traffic to a certain location or among many locations, regardless of whether the locations are all owned by the same user. For example, the customers stored in the database may be filtered by any desired criteria, such as age, gender, day of week that he/she enters the venue, spending habits, VIP rating, promotion or activity preference, zip code, or the like. In this way, venues, such as clubs, may target their advertising by selecting only those customers having certain characteristics and designing a marketing campaign specific for these customers. The targeted customers may be contacted in any desired manner, such as phone number, email, social media, or any other means of contact contained in the customer database.

In other examples, the customer database (e.g., database 330) can be used to target product marketing efforts based on customer activity at various locations. For example, since customer purchases can be tracked and stored in the customer database, the database may be filtered to identify those customers that show an affinity for a particular product, such as vodka. Companies selling that type of product may then design a marketing campaign specific for those customers. For example, notifications may be sent via phone, email, social media, text message, or the like, to the identified customers notifying them of a new product, special offer, or the like. The owner or operator of the customer database may charge a fee to those accessing information contained in the database for marketing purposes.

Other optional features of the present disclosure include allowing customers to link their customer records with social networking websites. This may allow customers to receive updates and information about special events using the customer's already existing social networking presence. In addition, the customer's social networking presence can be automatically updated when a customer enters a location. Linking with social networking websites may also allow the nightclubs to obtain further information about the customers so that future promotions and events may be better targeted to selected customers that will most likely attend such promotions and events.

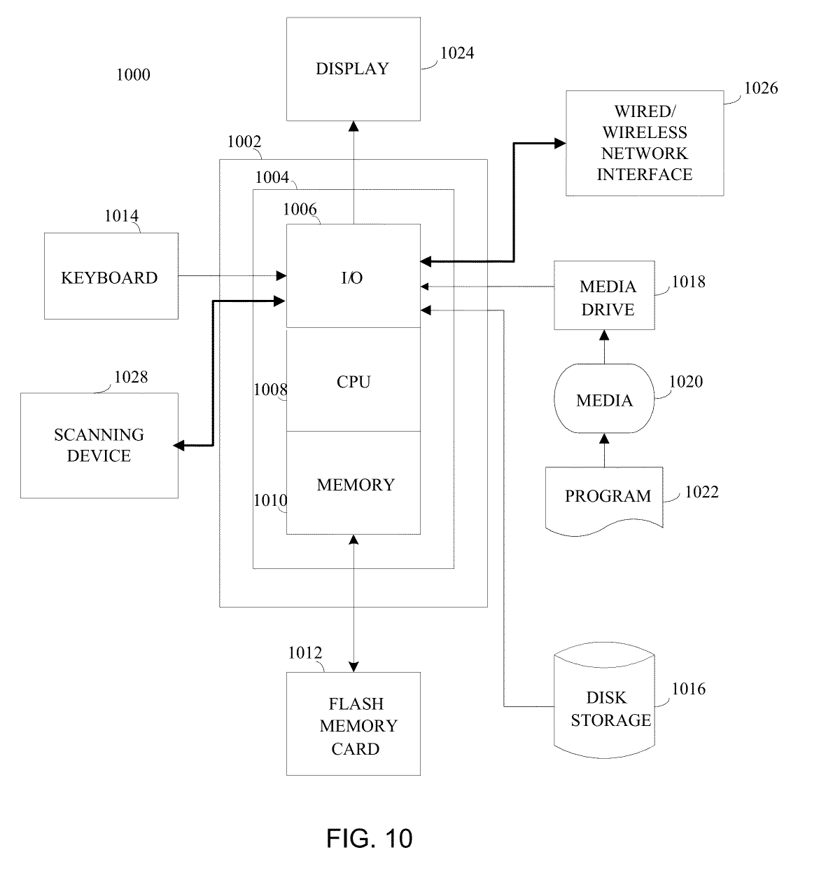

FIG. 10 depicts an exemplary computing system 1000 that may be configured as a customer management terminal to perform any one of the above-described operations. In this context, computing system 1000 may include, for example, a processor, memory, storage, and input/output devices (e.g., monitor, keyboard, disk drive, Internet connection, etc.). However, computing system 1000 may include circuitry or other specialized hardware for carrying out some or all aspects of the processes. In some operational settings, computing system 1000 may be configured as a system that includes one or more units, each of which is configured to carry out some aspects of the processes either in software, hardware, or some combination thereof.

The main system 1002 includes a motherboard 1004 having an input/output (“I/O”) section 1006, one or more central processing units (“CPU”) 1008, and a memory section 1010, which may have a flash memory card 1012 related to it. The I/O section 1006 is connected to a display 1024, a keyboard 1014, a disk storage unit 1016, and a media drive unit 1018. The media drive unit 1018 can read/write a non-transitory computer-readable storage medium 1020, which can contain programs 1022 or data. Networking interface 1026 may provide access to other customer management terminals and servers. Scanning device 1028 may be, for example, an optical, RF, or magnetic scanner.

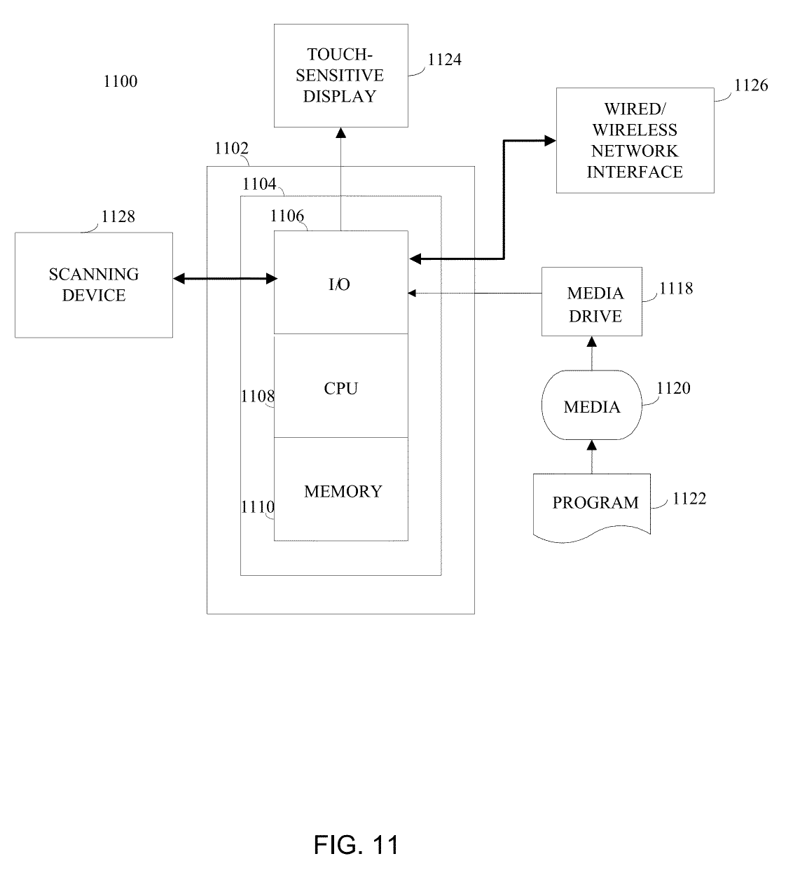

FIG. 11 depicts an exemplary handheld computer 1100 that may be configured as a customer management terminal to perform any one of the above-described operations. In this context, computing system 1100 may include, for example, a processor, memory, storage, and input/output devices (e.g., monitor, networking connection, etc.). However, computing system 1100 may include circuitry or other specialized hardware for carrying out some or all aspects of the processes. In some operational settings, computing system 1100 may be configured as a system that includes one or more units, each of which is configured to carry out some aspects of the processes either in software, hardware, or some combination thereof.

The main system 1102 includes a motherboard 1104 having an input/output (“I/O”) section 1106, one or more central processing units (“CPU”) 1108, and a memory section 1110, which may have a flash memory card 1112 related to it. The I/O section 1106 is connected to a display 1124, which is also touch sensitive to provide the user with the ability to enter information on the display, and a media drive unit 1118. The media drive unit 1118 can read/write a non-transitory computer-readable storage medium 1120, such as flash memory, which can contain programs 1122 or data. Networking interface 1126 may provide access to other customer management terminals and servers. Scanning device 1128 may be, for example, an optical, RF, or magnetic scanner.

A non-transitory computer-readable storage medium can be used to store (e.g., tangibly embody) one or more computer programs for performing any one of the above-described processes by means of a computer. The computer program may be written, for example, in a general purpose programming language (e.g., Pascal, C, C++) or some specialized application-specific language.

Although only certain exemplary embodiments have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. A method for tracking customer activity, the method comprising:
receiving customer identification information for a customer attempting to enter a location, wherein access to the location is restricted based one or more rules, and wherein the customer identification information was extracted from a first identification document that is encoded with the customer identification information;
verifying that the customer is authorized to enter the location based on the one or more rules;
causing a display of an indication of whether the customer is authorized to enter the location based on the one or more rules;
identifying a customer record associated with the customer in a customer database based on the customer identification information;
updating activity data of the customer record to reflect the customer entering the location;
tracking purchases made at the location using a second identification document associated with the customer; and
in response to the activity data indicating that the customer has entered the location and in response to identifying a match between the customer record and the second identification document, updating the customer record based on the tracked purchases.

2. The method of claim 1, wherein:
the customer information comprises a date of birth for the customer;
the one or more rules comprises a minimum age requirement; and
verifying that the customer is authorized to enter the location based on the one or more rules comprises calculating the customer's age based on the date of birth and comparing the calculated age with the minimum age requirement.

3. The method of claim 1, wherein identifying the customer record associated with the customer comprises:
in response to the customer not having a customer record in the customer database, causing a display of an interactive form to receive information for the customer;
receiving information entered into the interactive form; and
creating the customer record using the received information entered into the interactive form.

4. The method of claim 1, wherein receiving the customer identification information comprises receiving the customer identification information from a handled device comprising an optical scanner or a magnetic scanner, and wherein the handheld device extracted the customer identification information from the first identification document using the optical scanner or the magnetic scanner.

5. The method of claim 1, wherein the customer record associated with the customer comprises a name, a spending history, and an e-mail address for the customer.

6. The method of claim 1, further comprising:
in response to identifying the customer record associated with the customer, causing a display of at least a portion of data contained in the customer record.

7. The method of claim 1, wherein updating the activity data of the customer record comprises updating the customer record to include a date and time that the customer entered the location.

8. The method of claim 1, wherein the first identification document comprises a driver's license, and wherein the second identification document comprises a credit card.

9. The method of claim 8, wherein identifying a match between the customer record and the second identification document comprises comparing a name associated with the credit card with a name associated with the customer record.

10. The method of claim 1, wherein the customer database comprises a plurality of customer records, each record having contact information associated therewith, and wherein the method further comprises:
filtering the plurality of customer records using one or more criteria; and
transmitting a marketing message to the filtered customer records.

11. A non-transitory computer-readable storage medium for tracking customer activity, the non-transitory computer-readable storage medium comprising computer-executable instructions for:
receiving customer identification information for a customer attempting to enter a location, wherein access to the location is restricted based one or more rules, and wherein the customer identification information was extracted from a first identification document that is encoded with the customer identification information;
verifying that the customer is authorized to enter the location based on the one or more rules;
causing a display of an indication of whether the customer is authorized to enter the location based on the one or more rules;
identifying a customer record associated with the customer in a customer database based on the customer identification information;
updating activity data of the customer record to reflect the customer entering the location;
tracking purchases made at the location using a second identification document associated with the customer; and
in response to the activity data indicating that the customer has entered the location and in response to identifying a match between the customer record and the second identification document, updating the customer record based on the tracked purchases.

12. The non-transitory computer-readable storage medium of claim 11, wherein:
the customer information comprises a date of birth for the customer;
the one or more rules comprises a minimum age requirement; and
verifying that the customer is authorized to enter the location based on the one or more rules comprises calculating the customer's age based on the date of birth and comparing the calculated age with the minimum age requirement.

13. The non-transitory computer-readable storage medium of claim 11, wherein identifying the customer record associated with the customer comprises:
in response to the customer not having a customer record in the customer database, causing a display of an interactive form to receive information for the customer;
receiving information entered into the interactive form; and
creating the customer record using the received information entered into the interactive form.

14. The non-transitory computer-readable storage medium of claim 11, wherein receiving the customer identification information comprises receiving the customer identification information from a handled device comprising an optical scanner or a magnetic scanner, and wherein the handheld device extracted the customer identification information from the first identification document using the optical scanner or the magnetic scanner.

15. The non-transitory computer-readable storage medium of claim 11, wherein the customer record associated with the customer comprises a name, a spending history, and an e-mail address for the customer.

16. The non-transitory computer-readable storage medium of claim 11, further comprising instructions for:
in response to identifying the customer record associated with the customer, causing a display of at least a portion of data contained in the customer record.

17. The non-transitory computer-readable storage medium of claim 11, wherein the first identification document comprises a driver's license and the second identification document comprises a credit card, and wherein identifying a match between the customer record and the second identification document comprises comparing a name associated with the credit card with a name associated with the customer record.

18. The non-transitory computer-readable storage medium of claim 11, wherein the customer database comprises a plurality of customer records, each record having contact information associated therewith, and wherein the non-transitory computer-readable storage medium further comprises instructions for:
filtering the plurality of customer records using one or more criteria; and
transmitting a marketing message to the filtered customer records.

19. A system for tracking customer activity, the system comprising:
a customer management device configured to:
extract customer identification information for a customer attempting to enter a location, wherein access to the location is restricted based one or more rules, and wherein the customer identification information is extracted from a first identification document that is encoded with the customer identification information; and
transmit the customer identification information to a server; and
the server configured to:
identify a customer record associated with the customer in a customer database based on the customer identification information;
update activity data of the customer record to reflect the customer entering the location;
track purchases made at the location using a second identification document associated with the customer; and
in response to the activity data indicating that the customer has entered the location and in response to identifying a match between the customer record and the second identification document, update the customer record based on the tracked purchases.

20. The system of claim 19, wherein the customer management device comprises an optical scanner or a magnetic scanner, and wherein extracting the customer identification information comprises scanning the first identification document using the optical scanner or the magnetic scanner.

21. The system of claim 19, wherein updating the activity data of the customer record comprises updating the customer record to include a date and time that the customer entered the location.

22. The system of claim 19, wherein the first identification document comprises a driver's license and the second identification document comprises a credit card, and wherein identifying a match between the customer record and the second identification document comprises comparing a name associated with the credit card with a name associated with the customer record.

23. The system of claim 19, wherein the customer database comprises a plurality of customer records, each record having contact information associated therewith, and wherein the server is further configured to:
filter the plurality of customer records using one or more criteria; and
transmit a marketing message to the filtered customer records.
